(19) United States
(12) Patent Application Publication
(10) Pub. No.: US 2008/0243584 A1
(43) Pub. Date: Oct. 2, 2008

(54) METHODS AND SYSTEMS FOR ALLOCATING REPRESENTATIVES TO SITES IN CLINICAL TRIALS

(75) Inventor: Badhri N. Srinivasan, Raleigh, NC (US)

Correspondence Address: JOHN S. PRATT, ESQ;KILPATRICK STOCKTON, LLP, 1100 PEACHTREE STREET, ATLANTA, GA, 30309, US

(73) Assignee: Quintiles Transnational Corp., Durham, NC (US)

(21) Appl. No.: 12/023,687

(22) Filed: Jan. 31, 2008

Related U.S. Application Data
(60) Provisional application No. 60/898,463, filed on Jan. 31, 2007.

(51) Int. Cl. G06Q 10/00; G01C 21/00

(52) U.S. Cl. 705/9; 701/202

(57) ABSTRACT

Methods and systems for allocating representatives, such as clinical research associates (CRAs), to sites. One embodiment comprises a method for allocating CRAs to sites by determining for each CRA the first segment travel time from a starting location to a first node associated with a CRA, and the second segment travel time from the first node to a plurality of second nodes, wherein each second node is geographically associated with a site, determining the third segment travel time from each second hub to its corresponding site(s), for each CRA determining the aggregate travel time to each site by adding at least the first, second and third travel segments, for at least some of the CRAs and at least some of the sites, evaluating the aggregate travel times between CRAs to each of the sites, and allocating a CRA to allocate to each site based in part on the travel times.

### CROSS-REFERENCE TO RELATED APPLICATIONS

This application claims priority to U.S. Provisional Application Ser. No. 60/898,463 filed Jan. 31, 2007, entitled “Methods and Systems for Site Startup,” the entirety of which is incorporated herein by reference.

### FIELD OF THE INVENTION

Embodiments of the present invention relate generally to methods and systems for allocating representatives to destinations, including methods and systems for allocating Clinical Research Associates (CRAs) to clinical trial sites (sites), such as doctor offices.

### BACKGROUND

The U.S. Food and Drug Administration (FDA) approves drugs (and other medical products) after drugs have undergone numerous clinical studies to demonstrate the effectiveness and safety of the drugs. These clinical studies are based on data relating to the product's performance generated and reported by various sites in various geographic locations. The sites, such as doctors' offices, administer the potential products to patients, monitor the patients, and report the monitored result.

Pharmaceutical companies often use specialized research corporations to conduct the clinical trials. The research corporations typically retain numerous CRAs located in various geographic locations. The research corporations allocate each CRA to particular sites, so that each CRA can travel to his/her allocated sites to initiate and monitor the clinical trials. It is essential that CRAs build relationships with personnel at the various sites in order to ensure that sites operate and report the monitored results effectively, efficiently and timely, such that all the monitored data for the clinical studies can be collected and properly reported to the FDA for potential product approval.

Typically CRAs build relationships with their allocated sites by visiting the sites and interacting with the doctors and staff. The more often a particular CRA can visit a particular site, the more quickly and effectively the CRA can build a working relationship with the site, which typically results in better site performance. Thus, there is a need for a means to optimally determine the allocation of CRAs to sites, including in connection with particular clinical trials.

### SUMMARY

Embodiments of the present invention provide methods and systems that allocate CRAs to sites based in part on travel time, distance or airline flight segments from the CRA's associated location (e.g., nearby airport, or home or office location) to particular sites.

One embodiment of the present invention is a system for selecting and allocating CRAs to sites. A processor-based device is provided that is adapted to receive CRA and site data elements associated with CRA or site attributes from one or more databases. Each data element is associated with a CRA or site. The CRA attributes may include CRA starting location(s), CRA node location(s) and/or distance(s), CRA site assignments, CRA clinical trials experience, history of site visits, accuracy, effectiveness, and other performance metrics. The site attributes may include, site node location(s) and/or distance(s), number of past clinical trials, accuracy, effectiveness and/or timing of results and data, number of patients screened for enrollment, patient enrollment goal, actual patient enrollment, and other performance metrics. The processor-based device includes a CRA engine. The CRA engine is adapted to receive an inquiry for CRA allocation to a site, determine for each CRA the aggregate travel time or distance, or airline flight segment, to a particular site based in part on the available data elements, compare the travel times for the CRAs to the site, and allocate a specific CRA to the site based in part on the determined travel times.

Another embodiment is a method for selecting and allocating a CRA to a particular site based in part on a determined travel calculation. In this method, for each CRA the travel from a starting location associated with the CRA (e.g., home or office) to a CRA node (e.g., the airport requiring the least travel time, distance and/or flight segments from the CRA's starting location) is determined. The travel from the CRA node to the site node (such as for example, the number of flight segments) is also determined for each CRA. The travel from the site node to the corresponding site (e.g., doctor's office) is determined. For each CRA, the three independent travel components are added together to determine an aggregate travel value for the CRA to the site. The travel values for CRAs to the site can be compared and a specific CRA can be allocated/assigned to the site based in part on the determined travel values.

In another embodiment, methods are provided for selecting and allocating multiple CRAs to multiple sites using Transportation Problem algorithms. Yet in other embodiments, a computer-readable medium (such as, for example random access memory or a computer disk) comprises code for carrying out the methods.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1A is a diagram illustrating a geographic representation of a conventional method of assigning CRAs to a site;

FIG. 1B is a diagram illustrating a geographic representation of a method of allocating CRAs to a site according to one embodiment of the present invention;

FIG. 2 is another diagram illustrating a geographic representation of a method of allocating CRAs to a site according to one embodiment of the present invention;

FIG. 3 is another diagram illustrating a geographic representation of a method of allocating CRAs to a site according to one embodiment of the present invention;

FIG. 4 is a flow chart illustrating one method of allocating CRAs to sites according to one embodiment of the present invention;

FIG. 5 is a diagram illustrating a geographic representation of information considered by a Transportation Problem algorithm according to an example of an embodiment of the invention;

FIG. 6 is a flow chart illustrating a method carried out according to an example of one embodiment of the invention; and

FIG. 7 is a system diagram illustrating a CRA allocation system according to one embodiment of the resent invention.

### DETAILED DESCRIPTION

### Geographic Representations of CRA Allocation

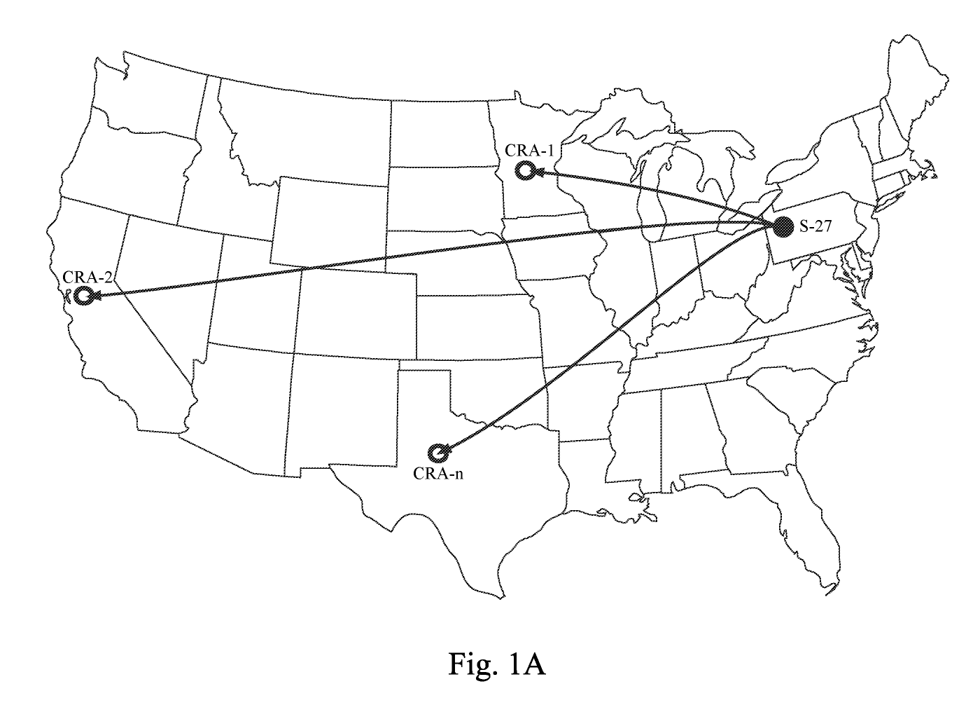

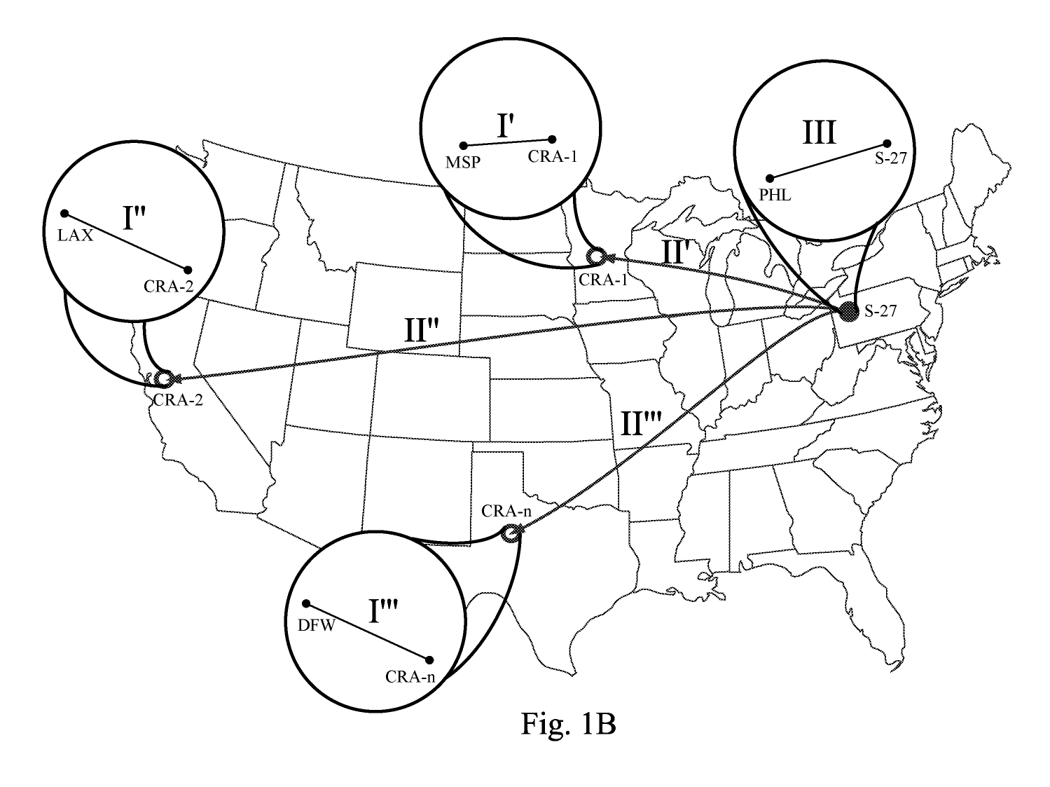

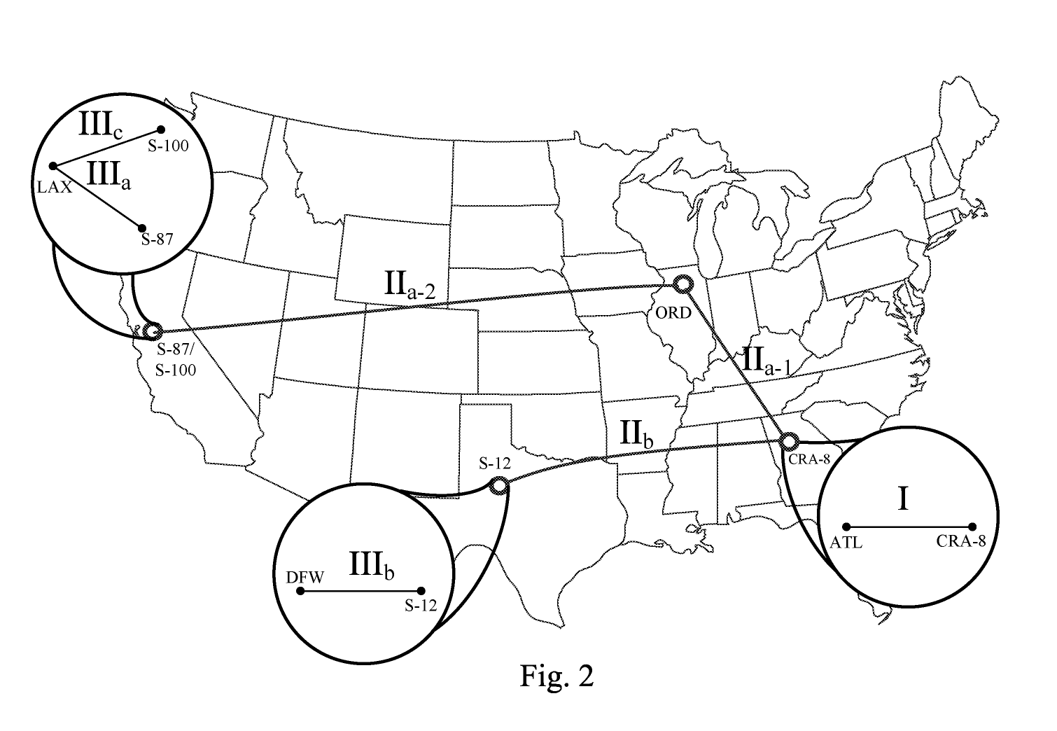

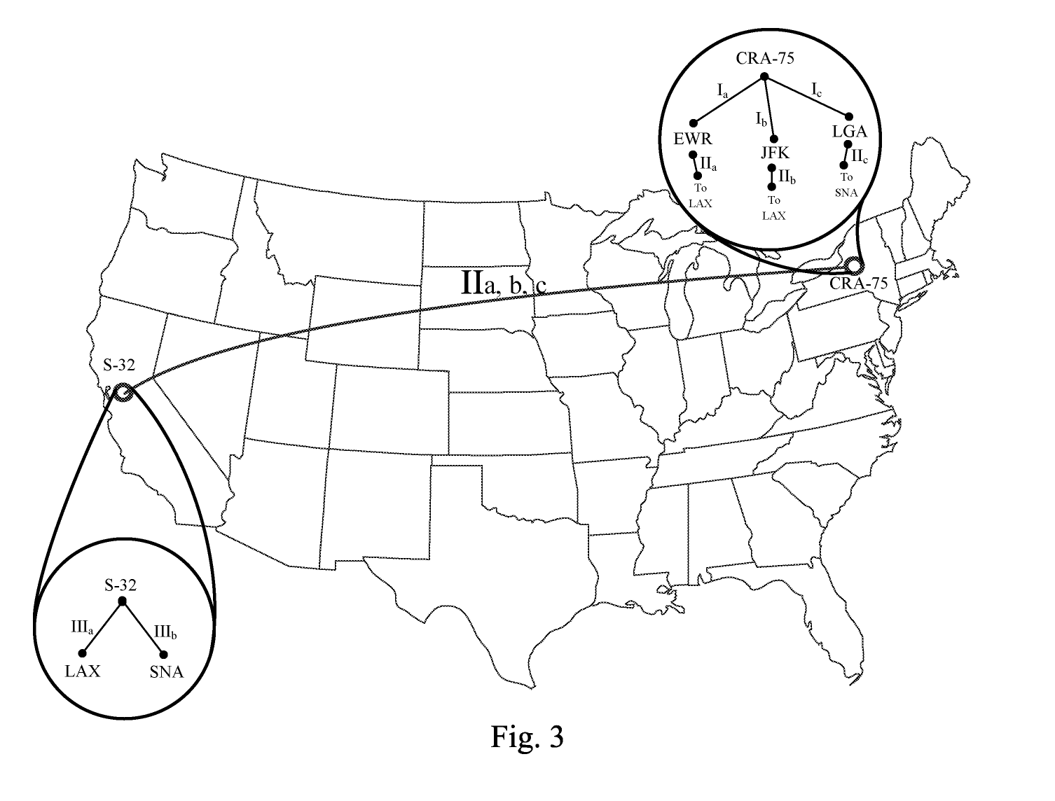

Referring now to the drawings in which like numerals indicate like elements throughout the several figures. Embodiments of the present invention provide methods and systems for the allocation of CRAs to sites. FIG. 1A is a diagram illustrating a geographic representation of CRA allocation according to a conventional technique, and FIG. 1B is a diagram illustrating a geographic representation of CRA allocation according to one embodiment of the present invention. FIGS. 2 and 3 are diagrams illustrating geographic representations of CRA allocation according to other embodiments of the present invention. Other embodiments may be utilized. Subscripts and superscripts are utilized throughout the figures for clarification and simplification purposes only and do not form any part of the present invention.

FIG. 1A illustrates an arbitrary number of CRAs, CRA-1, CRA-2, . . . , CRA-n. The illustrated locations of the CRAs show that CRAs may be located throughout a nation or on a wider geographical basis. Conventional allocation of CRA's to sites often involves happenstance, a CRA's history with a site, where the CRA lives or works and how close geographically the site is to that residence or workplace, history, and other factors. What has not happened in the past is to leverage use of specific data which has been collected and stored regarding CRA's and sites for the purpose of more effective and efficient assignment of CRA's to sites for purposes of carrying out clinical trials effectively and efficiency. The inventors have found that an important factor in this allocation is how close geographically each CRA who might get involved in a clinical trial is to a node in a transportation network such as a hub airport or train station, how close the sites are to various nodes, and how easy or difficult (including without limitation time, expense, frequency of flights or trains, flight or trip cost, and other factors), it is to travel from node to node. Such information can be useful in fitting an array of available CRA's to an array of sites for optimizing effectiveness and efficiency of clinical trials.

For example, a conventional technique of allocating CRAs to a site, determines that the travel distance from CRA-1 in Minneapolis to S-27 is Philadelphia is approximately 983 miles. The conventional CRA allocation method must also determine the travel distance to S-27 for the other CRAs: CRA-2 in Los Angeles, Calif. and CRA-n in Dallas, Tex. The conventional CRA allocation method determines the travel distance for all potential CRA assignments to be:

S-27

| | |
|---|---|
| CRA-1 | 983 miles |
| CRA-2 | 2409 miles |
| CRA-n | 1307 miles |

As shown in FIG. 1A and according to the calculated travel distances above, the conventional CRA allocation method would assign CRA-1 in Minneapolis to S-27 in Philadelphia because CRA-1 is the closest CRA to S-27.

FIG. 1B illustrates a geographic representation of CRA allocation of the same CRAs—CRA-1, CRA-2 and CRA-n to the same site—S-27 according to one embodiment of the CRA allocation method and system. According to one embodiment of the present invention, the travel time is calculated for each potential CRA assignment. As shown in FIG. 1B, the CRA allocation method determines the travel time for CRA-1 to S-27, CRA-2 to S-27, . . . , and CRA-n to S-27.

For each calculated travel time, three independently distinct travel time components/segments are taken into consideration: I) travel time from a CRA's starting location (e.g., home, work, another Site, etc.) to a CRA node (e.g., the quickest airport to arrive at from the starting location); II) travel time between CRA node and site node; and III) travel time from a site node to its corresponding site.

For example, based on FIG. 1B, the CRA allocation method determines that CRA-1's starting location is located 2.5 hours travel time to the CRA node—the Minneapolis-St. Paul International Airport (MSP node) (first segment travel time—I′ shown in FIG. 1B), the travel time from the MSP node to the site node—the Philadelphia International Airport (PHL node) is 2 hours (second segment travel time—II′ shown in FIG. 1B), and the travel time from the PHL node to S-27 is 0.5 hours (third segment travel time—III shown in FIG. 1B). Based on the travel time segments, the CRA allocation method determines that the total travel time for CRA-1 to S-27 is 5 hours (i.e., the three travel time segments I′, II′ and III added together −2.5+0.5+2).

In the present example, the CRA allocation method also determines that the travel time from CRA-2's starting location to its node—the Los Angeles International Airport (LAX node) is 0.5 hours (I″ shown in FIG. 1B) and the travel time from the LAX node to the PHL node is 4.5 hours (II″ shown in FIG. 1B). Based on the travel time components, the CRA allocation method determines that the total travel time for CRA-2 to S-27 is 5.5 hours (0.5+0.5+4.5).

Continuing the current example based on FIG. 1B, the CRA allocation method determines that the travel time from CRA-n's starting location to its node—the Dallas-Fort Worth International Airport (DFW node) is 1 hour (I′″ shown in FIG. 1B) and the travel time from the DFW node to the PHL node (II′″ shown in FIG. 1B) is 2.5 hours. Based on the travel components, the CRA allocation method determines that the total travel time for CRA-n to S-27 is 4 hours (1+0.5+2.5).

As illustrated by a comparison of FIGS. 1A and 1B, at first glance it appears that CRA-1 is the best choice to be allocated to S-27 based on travel distance, but as shown in the example described above for FIG. 1B, according to an embodiment of the CRA allocation method CRA-n has a shorter travel time (4 hours) to S-27 than CRA-1 (5 hours), so it may be more efficient to allocate CRA-n to S-27. A similar result may be achieved within the scope of the invention, whether or not travel time from CRA's residences to a node and from nodes to sites are taken into account, if, for example, the process recognizes that the Minneapolis CRA needs to change planes to visit the Philadelphia site while the Los Angeles CRA does not, if there are more flights daily from LAX, Ontario, John Wayne or other airports in the Los Angeles area to PHL to hedge for potential bad weather, or there are other circumstances that affect travel time and difficulty.

CRA allocation methods according to some embodiments of the invention compare the determined travel times for the CRAs to S-27 and select a CRA to allocate to S-27 based in part on the travel times. The CRA allocation method may take various other factors into consideration for allocating a CRA to S-27, such as costs, current number of sites CRAs are assigned to, etc. Thus the CRA allocation method may result in allocation of CRAs to sites in unexpected ways, resulting in unexpected results versus use of a conventional CRA allocation technique.

FIG. 2 illustrates the CRA/site allocation method according to one embodiment of the present invention. As shown in FIG. 2, the aggregate travel time for CRA-8 to S-12 involves a direct determination of the three travel time segments, wherein the travel time segments—I (CRA-8's starting location to its node—the Hartsfield-Jackson International Airport (ATL node), II_{b} (ATL node to S-12 node—the DFW node) and III_{b} (DFW node to S-12 location) are each calculated and added together to determine a total travel time for the potential CRA-8 allocation to S-12.

FIG. 2 also illustrates that calculation of the travel time segments, such as segment II, may include the calculation of intermediate nodes between the CRA node and the site node. As shown in FIG. 2, the calculation of travel time from CRA node—ATL to site node—LAX includes calculation of travel time from the ATL node to the intermediate node—the O'Hare International Airport (ORD node) (IIₐ₋₁) plus the travel time from the intermediate ORD node to the site node LAX (IIₐ₋₂) to determine a second segment travel time (i.e., IIₐ₋₁+IIₐ₋₂).

Additionally FIG. 2 illustrates that more than one site may be associated with a site node. As shown in FIG. 2, the LAX node may be associated with sites S-87 and S-100. Thus the CRA allocation method may calculate the third segment travel time for each site to the associated site node, so from LAX node to S-87 (IIIₐ) and LAX node to S-100 (III_{c}).

According to FIG. 2, the CRA allocation method would determine the aggregate travel time for CRA-8 to S-87 by adding the related three travel time segments—I+(IIₐ₋₁+IIₐ₋₂)+IIIₐ. Likewise the CRA allocation method would determine the aggregate travel time for CRA-8 to S-100 by adding the three travel time segments—I+(IIₐ₋₁+IIₐ₋₂)+III_{c}.

FIG. 3 illustrates a CRA/site allocation method according to another embodiment, wherein a CRA has more than one node and a site has more than one node. The CRA allocation method determines the travel time for CRA-75 to S-32, considering the various nodes. As shown in FIG. 3, CRA-75 may have three nodes at its disposal, Newark Liberty International Airport (EWR node), John F. Kennedy International Airport (JFK node) and La Guardia Airport (LGA node). The first segment travel time may be calculated for each node—CRA-75's starting location to EWR (Iₐ), CRA-75's starting location to JFK (I_{b}) and CRA-75's starting location to LGA (I_{c}).

CRA allocation methods according to certain embodiments of the invention may or may not calculate the travel times from each available CRA node to each available site node. For example based on other factors, such as costs efficiency, a CRA allocation method may not determine the travel time from a particular CRA node to a specific site node because the pair of nodes may be pre-set as an inappropriate or undesired node pair, thus no need to determine travel time. In the current example, FIG. 3 illustrates that the CRA allocation method determines the second segment travel times from the EWR node to the LAX node (IIₐ), from the JFK node to the LAX node (II_{b}), and from the LGA node to the John Wayne Airport (SNA node) (II_{c}). Also as shown in FIG. 3, a site—S-32 may have more than one site node—LAX and SNA. The CRA allocation method determines the third segment travel times from LAX to S-32 location (IIIₐ) and from SNA to S-32 location (III_{b}).

In FIG. 3, the CRA allocation method determines the aggregate travel time for the CRA-75 potential allocation to S-32, considering the various travel time components. The CRA allocation method determines the aggregate travel time from CRA-75 to S-32 via the EWR node to be Iₐ+IIₐ+IIIₐ. The CRA allocation method determines the aggregate travel time from CRA-75 to S-32 via the JFK node to be I_{b}+II_{b}+IIIₐ. As shown in FIG. 3, the CRA allocation method determines the aggregate travel time from CRA-75 to S-32 via the LGA node to be I_{c}+II_{c}+III_{b}.

Although the CRAs potential assignments to S-12, S-87, S-100, and S-32 are shown in two separate figures (FIGS. 2 and 3) for simplicity, embodiments of the present invention may include determining travel times for multiple CRAs to multiples sites contemporaneously.

### Illustrative System Implementation

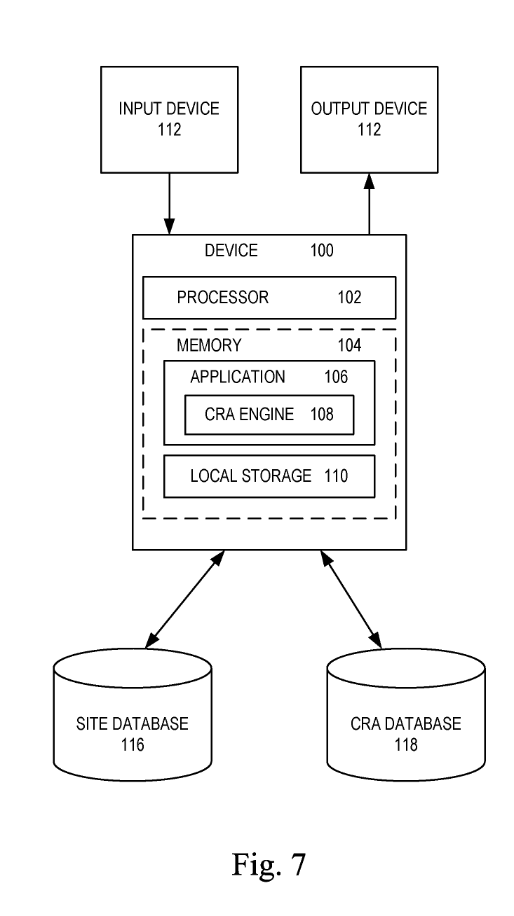

Methods according to various embodiments of the present invention may be implemented on a variety of different systems. An example of one such system is illustrated in FIG. 7. The system includes a processor-based device 100 that includes a processor 102 and a computer-readable medium, such as memory 104. The device may be any type of processor-based device, example of which include a computer and a server. Memory 104 may be adapted to store computer-executable code and data. Computer-executable code may include an application 106, such as a data management program that can be used to enter, edit, and view data associated with CRAs, sites, and clinical trials. The application 106 may include CRA engine 108 that, may be adapted to perform methods according to various embodiments of the present invention to provide information with which CRAs can be allocated to sites. In some embodiments, the CRA engine 108 may be a separate application that is executable separate from, and optionally concurrent with, application 106.

Memory 104 may also include a local storage 110 that is adapted to store data generated or received by the application 106 or CRA engine 108, or input by a user. In some embodiments, data storage 110 may be separate from device 100, but connected to the device 100 via wire line or wireless connection.

The device 100 may be in communication with an input device 112 and an output device 114. The input device 112 may be adapted to receive user input and communicate the user input to the device 100. Examples of an input device 112 includes a keyboard, mouse, scanner, network connection, and personal computer. User inputs can include commands that cause the processor 102 to execute various functions associate with the application 106 or the CRA engine 108. In some embodiments, the user may be required to supply authentication credentials to the processor-based device 100 via input device 112 before access to information and tools stored in the processor-based device 100 is granted to the user. The application 106 may receive the credentials from input device 112 and access data in local storage 110 to determine if the credentials match stored credentials and to identify the user.

The output device 114 may be adapted to provide data or visual output from the application 106 or the CRA engine 108. In some embodiments, the output device 114 can display a visual representation of data associated with CRAs and/or sites and provide a graphical user interface (GUI) that includes one or more selectable buttons or other visual inputs that are associated with various functions provided by the application 106 or the CRA engine 108. Examples of output device 114 include a monitor, network connection, printer, and personal computer.

In some embodiments of the present invention, the processor-based device 100 is a server and the input device 112 and output device 114 together form a second processor-based device such as a personal computer. The personal computer may be in communication with the processor-based device 100 via a network such as an internet or intranet. The CRA engine 108 may be adapted to send web pages to the personal computer for display and receive communications from the personal computer via the network.

The processor-based device 100 may also be in communication with one or more databases. One database may be a site database 116 and another database may be a CRA database 118. The site database 116 may include data elements associated with site attributes for each site. Each data element contains specific site attribute information regarding a site. For example, for an “accuracy” site attribute the site database may contain the following data elements: 20% for S-212; 88% for S-78; and 66% for S-205, wherein each data element represents an accuracy attribute value for a site. The site attributes can include site identification, site node location(s) and/or distance(s), surrounding area demographics (e.g., population data associated with a geographical area defined by a pre-set radius surrounding the physical location of the site), accuracy, and past clinical trial history. Past clinical trial history can include the number of past clinical trials in which the site participated, relative accuracy, effectiveness, and/or timing of results and data provided by the site, number of patients screened for enrollment, patient enrollment goal, actual patient enrollment, speed at which an enrollment goal was reached, and number of patients enrolled within a pre-set time period, such as sixteen months. The CRA database 118 may include CRA data elements associated with CRA attributes for each CRA that can be allocated to a site. Each data element contains specific CRA attribute information regarding a CRA. For example, for an “accuracy” CRA attribute the CRA database may contain the following data elements: 99% for CRA-487; 90% for CRA-808; and 92% for CRA-911, wherein each data element represents an accuracy attribute value for a CRA. The CRA attributes may include CRA starting location(s), CRA node location(s) and/or distance(s), CRA site assignments, CRA clinical trials experience, history of site visits, accuracy, effectiveness, and other performance metrics.

The site database 116 and CRA database 118 may be connected with the processor-based device 100 via wire line or wireless connection. The processor-based device 100 may communicate with the site database 116 and CRA database 118 via a network such as an internet or intranet and may be adapted to send and/or receive data from the site database 116 and CRA database 118. In some embodiments, the site database 116 and/or CRA database 118 include multiple databases, each storing site data and/or CRA data accessible to the processor-based device 100. In some embodiments, the processor-based device 100 may include the site database 116 and CRA database 118.

Data elements may be received for any number of CRAs and/or sites in any format. Examples of formats include extensible markup language (XML) and hypertext markup language (HTML). In some embodiments, CRA engine 108 may send a query for data elements of one or more CRA and/or site attributes to the site database 116 and/or the CRA database 118 over a network such as an internet. In response to the query, the site database 116 and/or CRA database 118 returns data elements of the requested attributes to the CRA engine 108 over the network. In other embodiments, the site database 116 and CRA database 118 periodically send updated data elements to the CRA engine, where they are stored in local storage 110.

### ONE ILLUSTRATIVE EMBODIMENT

A CRA Allocation system may consist of an arbitrary number of CRAs and/or sites. For example, if a system administrator has three (3) CRAs (CRA-1, CRA-2 and CRA-3) and wants to allocate a CRA to two (2) sites (S-1 and S-2), the CRA allocation method according to one embodiment would determine the travel times for each CRA to/from each site, to determine an aggregate travel time for each potential CRA assignment.

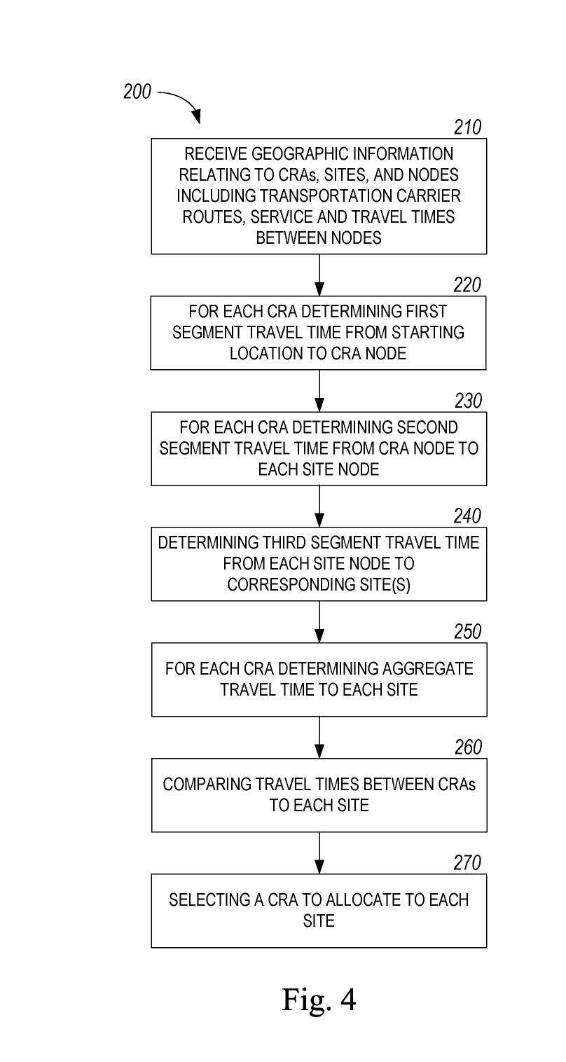

Various methods according to various embodiments of the present invention may be used to allocate CRAs to sites. FIG. 4 is a flow chart illustrating one method of allocating CRAs to sites. For purposes of illustration only, the elements of this method are described with reference to the system depicted in FIG. 7. A variety of other implementations are possible.

In the method 200 of allocating CRAs to sites shown in FIG. 4, geographic information (data elements) relating to numerous CRAs, numerous clinical trial sites, a plurality of CRA and site nodes, and information relating to transportation carrier routes, service and travel times between pairs of nodes are received in block 210. In block 210, the device 100 may receive the geographic information (data elements) from the input device 112 and may store the inputted geographic information in the local storage 110, site database 116, and/or CRA database 118. The inputted geographic information may include data elements associated with CRA attributes from the CRA database 118, such as CRA starting location, or data elements associated with site attributes from the Site database 116, such as site location.

For each CRA, the first segment travel time is determined from a CRA starting location to at least a first node associated with the CRA, as shown in block 220. In block 220, the processor 102 may receive data elements associated with CRA attributes from the input device 112 and the CRA database 118. Each data element includes information regarding a CRA. In some embodiments, the data elements are grouped into CRA attributes depending on the nature of the information they contain. The processor 102 may be configured to identify all data elements of all CRA attributes received from the CRA database 118 and/or input device 112 or a subset of the data elements. For example, in block 210 the processor 102 may be configured to only identify data elements regarding CRA starting location and CRA node attributes.

The starting location associated with the CRA could be a home address, corporate office, another site, etc. The starting location may include varied levels of information, such as a detailed address with a street name and number (e.g., 123 Rainbow Ln.) or only a zip code (e.g., 30309).

As mentioned, more than one CRA node may be accessible to a CRA. For example, CRA-1 may be near multiple nodes, such as the Washington Dulles International Airport (IAD node) and the Ronald Regan Washington National Airport (DCA node). In this case the CRA Allocation method may calculate the travel time from CRA-1's starting location to both CRA nodes, wherein the “first node” would be the first CRA node associated with the quickest travel time from the starting location of CRA-1 and the CRA node. In the present example, the CRA Allocation method determines that the travel time for CRA-1 to the IAD node is 1 hour and the travel time for CRA-1 to the DCA node is 1.5 hours. Thus, the IAD node is the first CRA node for CRA-1.

Additionally, a CRA node may be accessible to more than one CRA. For example, CRA node—the IAD node may be accessible to both CRA-1 and CRA-2. In the present example, the CRA Allocation method determines that the travel time for CRA-2 to the IAD node is 1.5 hours. The CRA Allocation method also determines that the travel time for CRA-3's starting location to its node, Miami International Airport (MIA node) is 2.5 hours.

For each CRA, the CRA allocation method determines second segment travel time from the accessible CRA node(s) to each of the site nodes, as shown in block 230. In block 230, the processor 102 receives data elements associated with site attributes and CRA attributes from the site database 116, CRA database 118, and/or input device 112. Each data element includes information regarding a CRA or site.

Travel time between CRA and site nodes may include flight time, bus travel, train ride, etc. For example, CRA-1 may arrive at a CRA node, the IAD node and take a flight to a site node, the ATL node. The CRA allocation method may determine the second travel segment (II)—travel time between CRA and site nodes by using travel carrier information provided by service providers, such as Delta Airlines, Amtrak, etc, wherein such information may include transportation carrier routes, available services and travel times between pairs of nodes. The processor 102 may receive the general data such as flight time from any source, including a database or other storage accessible to the processor 102 via a network. If there are multiple CRA nodes accessible to a CRA, the CRA allocation method may determine the travel time from some or all of the CRA nodes to each of the site nodes.

In the present example, the CRA Allocation method determines that the travel time from the IAD node (CRA node for CRA-1 and CRA-2) to the ATL node (in this example S-1 and S-2 have the same site node) is 2.5 hours. The CRA Allocation method may also determine that the travel time from the DCA node (CRA node for CRA-1) to the ATL node is 1.5 hours (II) and the travel time from the MIA node (CRA node for CRA-3) to the ATL node is 1.5 hours.

The CRA allocation method determines third segment travel time for each of the site nodes to its corresponding site(s), as shown in block 240. In block 240, the processor 102 receives data elements associated with site attributes from the site database 116 and/or input device 112. Each data element includes information regarding a site. In some embodiments, the data elements are grouped into site attributes depending on the nature of the information they contain.

A site may have multiple corresponding site nodes, in which case the CRA allocation may determine the travel time from each site node to the site. Additionally, a site node may have multiple corresponding sites, in which case the CRA allocation method may determine the travel time from the site node to each site. For example, the ATL node may have corresponding S-1 and S-2. In this case the CRA Allocation method may determine the travel time from the ATL node to both S-1 and to S-2. In the present example, the CRA Allocation method determines that the travel time from the ATL node to its corresponding sites, S-1 is 2.5 hours and S-2 is 1.5 hours.

Each travel time component is independently variable and the determined travel times may be adjusted based in part on corresponding traffic conditions, construction impediments, weather conditions, etc. Additionally, the travel time components may each use a different mode of transportation or a different carrier than the other travel times. For example, CRA-1 may access a CRA node via car, travel to the site node via airplane, and then travel to the site location via subway. Any combination of transportation modes are possible.

In the method 200 of allocating CRAs to sites, for each of the CRAs, the aggregate travel time to each of the sites is determined, as shown in block 250. According to one embodiment of the present invention, the aggregate travel time for each potential CRA assignment may be determined by summing the corresponding travel time components for each CRA for each site (i.e., first segment+second segment+third segment). For example, to determine the aggregate travel time for CRA-1 to site S-1 through the IAD node, the determined travel time (1 hour) from CRA-1's starting location to the CRA IAD node (as shown in block 220) is added to the determined travel time (2.5 hours) from the CRA node to the corresponding site node for S-1 (as shown in block 230) plus the determined travel time (2.5 hours) from the corresponding site node to S-1 (as shown in block 240), for a total travel time of 6 hours (1+2.5+2.5).

The aggregate travel time for CRA-1 to S-1 through the DCA node (second CRA node) is 5.5 hours (1.5+2.5+1.5). The aggregate travel time for CRA-1 to S-2 through the IAD node is 5 hours (1+1.5+2.5) and through the DCA node is 4.5 hours (1.5+1.5+1.5).

The aggregate travel time for CRA-2 to S-1 is 6.5 hours (1.5+2.5+2.5) (in the example IAD node was the only accessible node for CRA-2) and to S-2 is 5.5 hours (1.5+1.5+2.5). The aggregate travel time for CRA-3 to S-1 is 6.5 hours (2.5+2.5+1.5) and to S-2 is 5.5 hours (2.5+1.5+1.5).

In the present example, the CRA allocation method determines the aggregate travel time for all potential CRA assignments to be:

| | S-1 | S-2 |
|---|---|---|
| CRA-1 | First CRA Node 6 | First CRA Node 5 |
| | Second CRA Node 5.5 | Second CRA Node 4.5 |
| CRA-2 | 6.5 | 5.5 |
| CRA-3 | 6.5 | 5.5 |

The CRA allocation method compares and evaluates the aggregate travel times between the CRAs to the sites, as shown in block 260. The CRA allocation method may evaluate each CRA's travel time to a particular site, a group of sites, etc. The CRA allocation method may compare all, some, a random or selected group of CRA's travel times to sites. For example, the CRA allocation method may compare the travel times of its top two most efficient CRAs to a difficult site in an effort to determine which top CRA should be assigned to the difficult site.

The CRA allocation method allocates a CRA to each of the sites, as shown in block 270. In some embodiments, the selected CRA allocations may be stored in the CRA database 118. The CRA allocation method selects a CRA to assign to each site based in part on the determined travel times. For example, the CRA allocation method may determine a number rank of “one” for the CRA having the relative “best” travel time to a particular site compared to other CRA travel times, a number rank of “two” for the CRA having the next “best” travel time to the particular site, and so on, until a number rank is determined for each potential CRA assignment to the particular site. In some embodiments, CRAs that have the same travel time to a particular site may receive the same number rank. In block 270, the processor 102 associates or links the number rankings with their respective CRAs and stores the associations in local storage 110. The number rankings including the travel times may be available to the processor 102 for future uses.

In this present example, at first glance it appears that CRA-1 (traveling through its second CRA node) should be allocated to both S-1 and S-2. However, the CRA allocation method may also consider many additional factors, such as the current number of sites to which CRA-1 is allocated, whether CRA-3 already has a relationship with S-2, etc. The CRA allocation method may also consider pre-set data that may be data previously provided to the processor 102 that relates to preferred, average, and non-preferred information or values for potential site assignments. Examples of pre-set data includes a preferred travel time between sites and site nodes, travel times considered generally acceptable but less preferred, and travel times that are not preferred. In some embodiments, the pre-set data may be provided to the processor-based device 100 via input device 112.

The CRA allocation method may consider the travel times based on either one-way or roundtrip travel. The CRA allocation method may or may not take into consideration all potential travel routes and/or all potential travel times, including time of the day and days of the week. The CRA allocation method may consider travel time related factors such as direct flights versus in-direct flights (e.g., including layovers), different travel modes (e.g. travel to nodes via car versus public transportation), different carriers (e.g. Delta flight times versus United Way flight times). Each of the travel time components may be determined in numerous ways, such as an estimated travel time based on distance, actual travel times, etc. and may include consideration of dynamic conditions, such as traffic, weather conditions, construction, etc. The CRA Allocation method may also take into consideration many other factors, such as time to obtain a rental car once a CRA arrives at a site node, which may be included in the travel time calculation of site node to site, the number of sites allocated to a CRA, if a particular CRA is more effective with dealing with difficult sites (and thus may be more optimal for those sites that have a history of poor performance), if a CRA is bilingual, if a CRA already has a contact (relationship) with a site, if a CRA has requested to be or not to be assigned to a site, if this will be temporary or permanent CRA assignment, etc.

### ILLUSTRATIVE EXAMPLE

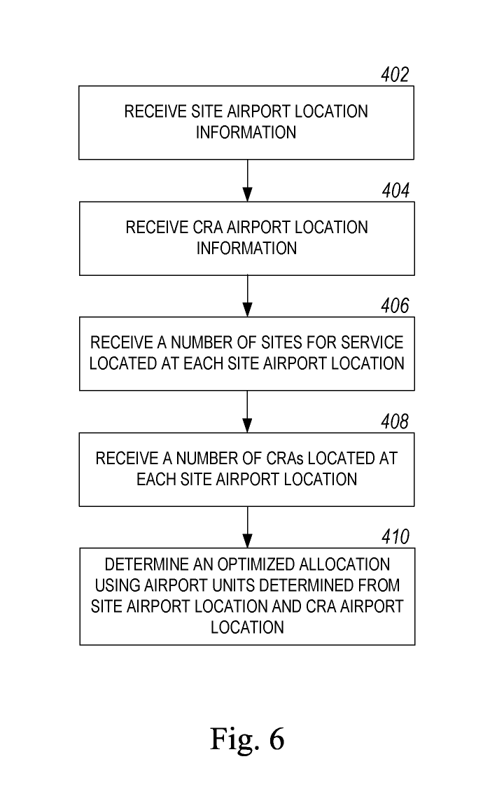

In one method according to one embodiment of the invention, certain information is received by the CRA engine 108 and used in conjunction with a Transportation Problem algorithm, such as that disclosed in, for example, Introduction to Operations Research By Frederick S. Hillier, Gerald J. Lieberman. Published by McGraw Hill (2004), which is incorporated herein by this reference to determine CRA allocation. The CRA engine 108 may include the Transportation Problem algorithm or the Transportation Problem algorithm may be a separate component within application 106 or a separate application. FIG. 6 is a flow chart illustrating the embodiment using the Transportation Problem algorithm. Any algorithm adapted to optimize allocations based on certain information, however, may be used, including algorithms conventionally used in the field of Operations Research.

In block 402, the CRA engine 108 receives site airport location information. The site airport location information may include an identification of airport locations for which sites eligible to participate, or who are selected to participate, in clinical trials are located in proximity. In some embodiments, the CRA engine 108 receives site airport location information for airports for which a site is located within a pre-set radius with respect to the airport location.

In block 404, the CRA engine 108 receives CRA airport location information. The CRA airport location information may include an identification of airports for which eligible CRA's are located in proximity. In some embodiments, the CRA engine 108 receives CRA airport location information for airports for which a CRA is located within a pre-set radius with respect to the airport location.

In block 406, the CRA engine 108 receives a number of sites that need to be serviced at each site airport location. The number of sites that need to be serviced may be determined by the CRA engine 108 based on site information received from site database 116 and/or clinical trial information. In some embodiments, the CRA engine 108 may be adapted to select sites that need to be serviced based on a number of factors, some of which include the past performance of the sites in clinical trials, the medical specialty in which the site practices, and/or the subject matter of a clinical trial.

In block 408, the CRA engine 108 receives a number of CRAs that are located at each site airport location. In some embodiments, the CRA engine 108 is adapted to determine the number of CRAs that are located at each site airport location using information from the CRA database 118 and the airport locations. For example, the CRA engine 108 may identify and count CRAs who are located within a pre-set radius of an airport location.

In block 410, the CRA engine 108 accesses an optimization algorithm, such as the Transportation Problem algorithm, and uses it to optimize allocation of CRAs to sites based on airport units and, in some embodiments, to minimize the number of airport units required. An airport unit may be the number of airline flight segments between at least some of the site airport locations and the CRA airport locations.

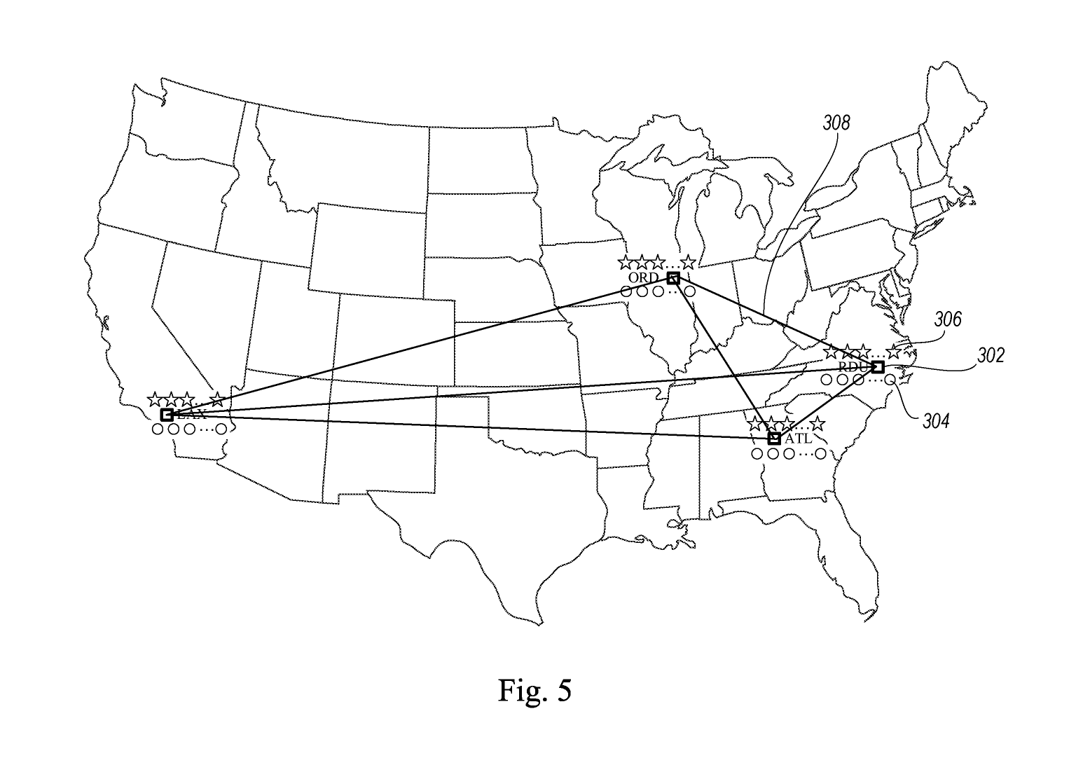

FIG. 5 show a map that schematically depicts information considered by the Algorithm. Site Airport Locations are shown using numeral 302, Sites are shown using numeral 304, CRA's are shown using numeral 306, and Airport Units are shown using numeral 308. FIG. 6 is a flowchart showing steps carried out in Example 1.

### General

The foregoing description of the embodiments of the invention has been presented only for the purpose of illustration and description and is not intended to be exhaustive or to limit the invention to the precise forms disclosed. Numerous modifications and adaptations are apparent to those skilled in the art without departing from the spirit and scope of the invention.

That which is claimed:

1. A method for allocating a clinical research associate (CRA) to a clinical trial site, the method comprising:
receiving CRA geographic information comprising a location for each of a plurality of CRAs;
receiving site geographic information comprising a location for each of a plurality of clinical trial sites;
receiving hub geographic information comprising a location for each of a plurality of transportation hubs;
determining a CRA hub for each of the plurality of CRAs based on the CRA geographic information and the hub geographic information, the CRA hub comprising at least one of the plurality of transportation hubs;
determining a site hub for each of the plurality of clinical trial sites based on the site geographic information and the hub geographic information, the site hub comprising at least one of the plurality of transportation hubs;
determining a plurality of segments using the hub geographic information, wherein each of the plurality of segments comprises factors associated with a route between at least two of the plurality of transportation hubs;
determining an allocation plan for at least one of the plurality of CRAs using the plurality of segments, the CRA hub, and the site hub; and
outputting the allocation plan.

2. The method of claim 1, wherein the factors associated with a route between at least two of the plurality of transportation hubs comprises at least one of:
travel time;
distance;
travel delay likelihood;
carrier schedule; and
travel cost.

3. The method of claim 1, further comprising:
determining a plurality of CRA segments, each of the plurality of CRA segments comprising travel time or distance information from a CRA location to its CRA hub;
determining a plurality of site segments, each of the plurality of site segments comprising travel time or distance information from a site location to its site hub; and
wherein determining the allocation plan further comprises using at least one of the plurality of CRA segments and at least one of the plurality of site segments.

4. The method of claim 1, wherein each of the plurality of transportation hubs comprises an airport.

5. The method of claim 1, further comprising:
receiving a number of clinical trial sites to which each of the plurality of CRAs is responsible; and
wherein determining the allocation plan further comprises using the number of clinical trial sites.

6. A method of allocating a plurality of clinical trial representatives to a plurality of clinical sites, comprising:
a. receiving geographic information relating to a plurality of clinical trial representatives, geographic information relating to a plurality of clinical trial sites, geographic information relating to a plurality of nodes, and information relating to transportation carrier routes, service and travel times between pairs of nodes in said plurality of nodes;
b. for each representative, determining:
a first segment travel time from a starting location associated with the representative to at least a first node, wherein the first node is associated with the representative;
a second segment travel time from the first node to each of a plurality of second nodes using the information relating to transportation carrier routes, service and travel times between nodes, wherein each of the plurality of second nodes corresponds to a site;
a third segment travel time from each of the plurality of second nodes to its corresponding site; and
an aggregate travel time to each of the sites by adding at least the first, second and third segment travel times;
c. for at least some of the representatives and at least some of the sites:
evaluating the aggregate travel times between representatives to each of the sites; and
allocating a representative to each of the sites based at least in part on the determined aggregate travel times; and
d. updating a clinical trial representative database with the selected allocations.

7. The method of claim 6, wherein at least some of the nodes correspond to airports.

8. The method of claim 6, wherein the starting location is selected from a group consisting of home location, office location, or another site location.

9. The method of claim 6, wherein calculation of the second segment travel time from the first node to each of the second nodes is based on a different mode of transportation than calculation of the first segment travel time from the starting location to the first node.

10. The method of claim 6, further comprising:
adjusting determined travel times based at least in part on corresponding traffic conditions.

11. The method of claim 6, further comprising:
adjusting determined travel times based at least in part on corresponding weather conditions.

12. The method of claim 6, wherein allocating a representative to each of the sites further comprises: determining the number of sites each representative is currently allocated to.

13. A system for allocating a plurality of clinical trial representatives to a plurality of clinical trial sites, the system comprising:
a processor comprising an application and a CRA engine, the application adapted to receive information from an input device, the information comprising:
geographic information data elements associated with a plurality of clinical trial representative attributes for a plurality of clinical trial representatives;
a plurality of clinical trial site attributes for a plurality of clinical trial sites;
a plurality of nodes; and
information data elements related to transportation carrier routes, service and travel times between pairs of nodes in said plurality of nodes;
a representative database for storing the plurality of data elements associated with the plurality of representative attributes for the plurality of representatives;
a site database for storing the plurality of data elements associated with the plurality of site attributes for the plurality of sites;
a local database for storing the plurality of data elements associated with the plurality of nodes and the plurality of data elements associated with transportation carrier routes, service and travel times between pairs of nodes in said plurality of nodes;
wherein the CRA engine is adapted to determine an allocation of representatives based on data elements received from the representative database and site database by:
receiving a request from the input device for allocation of representatives; for each representative:
determining a first segment travel time from a starting location associated with the representative to at least a first node, each of which first nodes is related to a representative; and
determining a second segment travel time from the first node to each of a plurality of second nodes, using the data elements associated with transportation carrier routes, service and travel times between nodes;
determining a third segment travel time from each of the plurality of second nodes to its corresponding site; and
determining an aggregate travel time to each of the sites by adding at least the first, second and third segment travel times;
for at least some of the representatives and at least some of the sites:
evaluating the aggregate travel times between representatives to each of the sites; and
allocating a representative to allocate to each of the sites based at least in part on the determined aggregate travel times; and
outputting the selected allocations to an output device.

14. The system of claim 13, wherein the CRA engine is further adapted to authenticate a user.

15. The system of claim 13, wherein at least some of the nodes correspond to airports.

16. The system of claim 13, wherein determining travel times further comprises:
adjusting determined travel times based at least in part on corresponding traffic conditions.

17. The system of claim 13, wherein determining travel times further comprises:
adjusting determined travel times based at least in part on corresponding weather conditions.

18. The system of claim 13, wherein allocating a representative to each of the sites further comprises:
determining the number of sites each representative is currently allocated to.

19. A computer-readable medium having computer executable instructions for:
receiving a plurality of data elements associated with a plurality of clinical trial representative attributes for a plurality of clinical trial representatives;
receiving a plurality of data elements associated with a plurality of clinical trial site attributes for a plurality of clinical trial sites;
receiving a plurality of data elements associated with a plurality of nodes;
receiving a plurality of data elements associated with a plurality of transportation carrier routes, service and travel times between pairs of nodes in said plurality of nodes;
receiving a request for allocation of representatives;
for each representative:
determining a first segment travel time from a starting location associated with the representative to at least a first node, each of which first nodes is related to a representative; and
determining a second segment travel time from the first node to each of a plurality of second nodes, each of which second nodes is geographically related to a site;
determining a third travel time from each of the plurality of second nodes to its corresponding site; and
determining an aggregate travel time to each of the sites by adding at least the first, second and third segment travel times;
for at least some of the representative and at least some of the sites:
evaluating the aggregate travel times between representatives to each of the sites; and
allocating a representative to each of the sites based at least in part on the determined aggregate travel times; and
outputting the selected allocations to an output device.

20. A method comprising:
receiving site airport locations, the site airport locations comprising an identification of a plurality of airports for which at least one clinical trial site eligible to conduct a clinical trial is located within a pre-set radius;
receiving Clinical Research Associate (CRA) airport locations, the CRA airport locations comprising an identification of a plurality of airports for which at least one CRA is located within a pre-set radius;
receiving a number of clinical trial sites to service associated with each of the site airport locations;
receiving a number of CRAs associated with each of the site airport locations;
determining CRA allocation for at least one CRA using a Transportation Problem algorithm, site airport locations, CRA airport locations, the number of clinical trial sites to service associated with each of the site airport locations, and the number of CRAs associated with each of the site airport locations; and
outputting the CRA allocation.

21. The method of claim 20, wherein the number of clinical trial sites to service associated with each of the site airport locations comprises an identification of each clinical trial site located within a pre-set radius of a site airport location for which the number of clinical trial sites is being determined.

22. The method of claim 20, wherein the number of CRAs associated with each of the site airport locations comprises an identification of each CRA located within a pre-set radius of a site airport location for which the number of CRAs is being determined.

23. The method of claim 20, wherein the Transportation Problem algorithm is adapted to optimize the CRA allocation based on at least one airport unit, wherein the airport unit comprises a number of flight segments between a site airport location and a CRA airport location.
